(19) United States
(12) Patent Application Publication
(10) Pub. No.: US 2014/0221156 A1
(43) Pub. Date: Aug. 7, 2014

(54) CONTROL DEVICE AND CONTROL METHOD FOR VEHICLE

(71) Applicants: Toshio SUGIMURA, Nagoya-shi (JP); Seiji KUWAHARA, Toyota-shi (JP); Takahiko TSUTSUMI, Nisshin-shi (JP); Koki MINAMIKAWA, Nagoya-shi (JP); Shun SATO, Toyota-shi (JP)

(72) Inventors: Toshio SUGIMURA, Nagoya-shi (JP); Seiji KUWAHARA, Toyota-shi (JP); Takahiko TSUTSUMI, Nisshin-shi (JP); Koki MINAMIKAWA, Nagoya-shi (JP); Shun SATO, Toyota-shi (JP)

(73) Assignee: TOYOTA JIDOSHA KABUSHIKI KAISHA, Toyota-shi (JP)

(21) Appl. No.: 14/170,261

(22) Filed: Jan. 31, 2014

(30) Foreign Application Priority Data
Feb. 4, 2013 (JP) 2013-019498

(51) Int. Cl. B60W 10/06; B60W 10/10; B60W 10/02

(52) U.S. Cl. CPC B60W 10/06; B60W 10/02; B60W 10/10
USPC 477/83

(57) ABSTRACT

A control device for a vehicle that includes an engine, a motor, and a clutch provided in a power transmission path between the engine and the motor. The control device includes an ECU. The ECU is configured to switch travel states of the vehicle from a first to a second travel state. In the first travel state, the vehicle travels by using driving force generated by at least the engine while the clutch is engaged. In the second travel state, the vehicle travels by using driving force generated by the motor while the engine is stopped and the clutch is disengaged. The ECU is configured to maintain an operation of the engine and keep the clutch engaged after target driving force of the engine changes to a negative value when disengagement of the clutch is prohibited in switching from the first travel state to the second travel state.

### INCORPORATION BY REFERENCE

The disclosure of Japanese Patent Application No. 2013-019498 filed on Feb. 4, 2013 including the specification, drawings and abstract is incorporated herein by reference in its entirety.

### BACKGROUND OF THE INVENTION

1. Field of the Invention

The present invention relates to a control device and a control method for a vehicle.

2. Description of Related Art

A driving device for a hybrid vehicle that includes an engine, a motor, a clutch provided in a power transmission path between the engine and the motor has been known. A technique for such a driving device for a hybrid vehicle has been known that switches a first travel state where the vehicle travels by using driving force generated by at least the engine while the clutch is engaged and a second travel state where the vehicle travels by using driving force generated by the motor while the engine is stopped and the clutch is disengaged. An example is a mode switching control device for a hybrid driving device disclosed in Japanese Patent Application Publication No. 2007-253780 (JP 2007-253780 A).

In switching from the first travel state to the second travel state in the driving device for a hybrid vehicle, there may be a case where disengagement of the clutch is prohibited such as a case where the temperature of the clutch is a specified value or higher and heat generation by slip should be reduced. When such a case occurs in JP 2007-253780 A, for example, the engine revolves because the clutch is kept engaged, and inertia travel of the vehicle is performed by an artificial engine brake using a regenerative brake of the motor. Then, the clutch is disengaged after disengagement of the clutch is permitted.

### SUMMARY OF THE INVENTION

The above inertia travel generates friction torque because the engine revolves due to engagement of the clutch. Accordingly, the engine braking effect may be temporary reduced because the friction torque is reduced when the clutch is disengaged, and a driver may experience awkwardness.

The present invention provides a control device and a control method for a hybrid vehicle that reduces awkwardness experienced by the driver when the clutch is disengaged.

A first aspect of the present invention provides a control device for a vehicle including an engine, a motor, and a clutch provided in a power transmission path between the engine and the motor, and the control device includes an electronic control unit. The electronic control unit is configured to switch travel states of the vehicle from a first travel state to a second travel state. In the first travel state, the vehicle travels by using driving force generated by at least the engine while the clutch is engaged. In the second travel state, the vehicle travels by using driving force generated by the motor while the engine is stopped and the clutch is disengaged. The electronic control unit is configured to maintain an operation of the engine and keep the clutch engaged after target driving force of the engine changes to a negative value in a case where disengagement of the clutch is prohibited in switching from the first travel state to the second travel state.

According to the configuration, occurrence of reduction of the engine braking effect caused by the reduction of the friction torque in disengagement of the clutch can properly be hindered. In other words, awkwardness experienced by the driver in disengagement of the clutch can be reduced.

In the control device, the electronic control unit may be configured to perform control to make output torque of the engine as small as possible until disengagement of the clutch is permitted in a case where disengagement of the clutch is prohibited in switching from the first travel state to the second travel state. According to the configuration, for example, the engine brake is in advance covered by the torque of the motor, and the occurrence of the reduction of the engine braking effect caused by the reduction of the friction torque in disengagement of the clutch can further properly be hindered.

In the control device, the electronic control unit may be configured to make output torque of the engine approximately zero and keep the clutch engaged until disengagement of the clutch is permitted in a case where disengagement of the clutch is prohibited in switching from the first travel state to the second travel state.

In the control device, the electronic control unit may be configured to cause the motor to generate torque that cancels engine brake torque of the engine until disengagement of the clutch is permitted in a case where disengagement of the clutch is prohibited in switching from the first travel state to the second travel state.

In the control device, the electronic control unit may be configured to cause the motor to generate torque that makes friction torque of an output shaft of the engine approximately zero until disengagement of the clutch is permitted in a case where disengagement of the clutch is prohibited in switching from the first travel state to the second travel state.

In the control device, the electronic control unit may be configured to cause the motor to generate negative torque that cancels friction torque of an output shaft of the engine until disengagement of the clutch is permitted in a case where disengagement of the clutch is prohibited in switching from the first travel state to the second travel state.

A second aspect of the present invention provides a control method for a vehicle including an engine, a motor, and a clutch provided in a power transmission path between the engine and the motor. The method includes: maintaining an operation of the engine and keeping the clutch engaged with an electronic control unit, after target driving force of the engine changes to a negative value in a case where disengagement of the clutch is prohibited in switching from the first travel state to the second travel state. The first travel state is a state where the vehicle travels by using driving force generated by at least the engine while the clutch is engaged. The second travel state is a state where the vehicle travels by using driving force generated by the motor while the engine is stopped and the clutch is disengaged.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 conceptually illustrates a configuration of a drive system in accordance with a hybrid vehicle to which an embodiment of the present invention is applied;

FIG. 2 is a function block diagram that illustrates essential parts of a control function included in an electronic control device in the hybrid vehicle in FIG. 1;

FIG. 3 is a time chart that illustrates an example of control of this embodiment by the electronic control device in FIG. 2; and

FIG. 4 is a flowchart that illustrates essential parts of an example of clutch disengagement control by the electronic control device in FIG. 2.

### DETAILED DESCRIPTION OF EMBODIMENTS

An embodiment of the present invention will hereinafter be described in detail with reference to drawings.

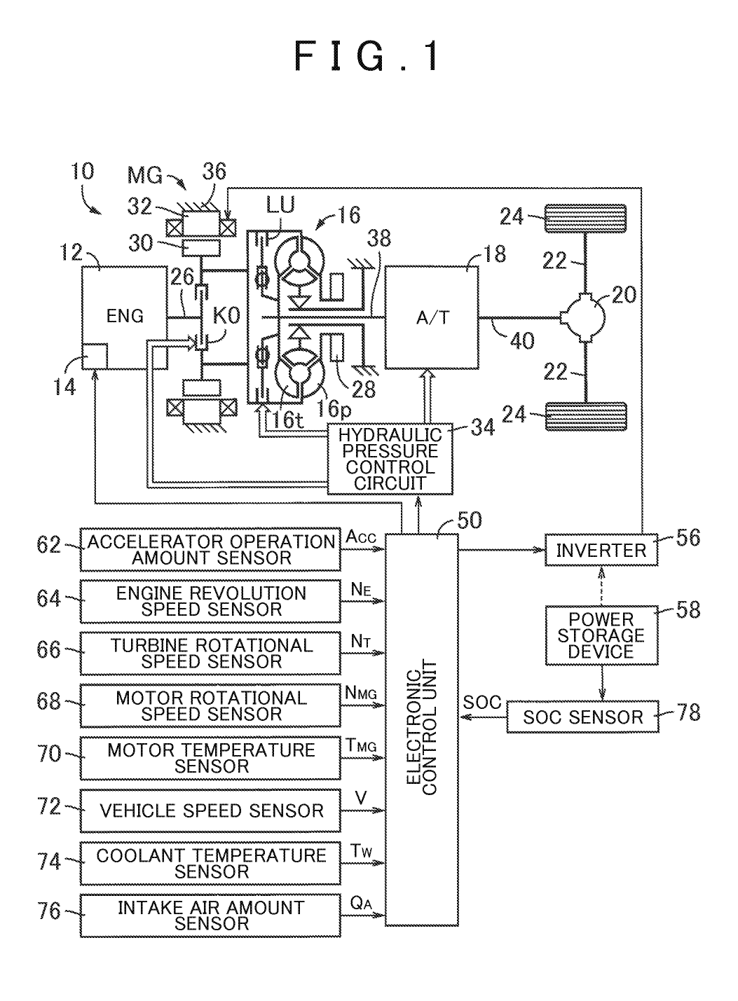

FIG. 1 conceptually illustrates a configuration of a drive system in accordance with a hybrid vehicle 10 in this embodiment. The hybrid vehicle 10 shown in FIG. 1 includes an engine 12 and a motor MG as drive sources. Driving force generated by the engine 12 and the motor MG is transmitted to a pair of left and right driving wheels 24 via a torque converter 16, a transmission 18, a differential gear device 20, and a pair of left and right axles 22. Each of the motor MG, the torque converter 16, and the transmission 18 is housed in a transmission case 36. The transmission case 36 is a splittable case made of aluminum die cast parts, for example, and fixed to a non-rotating member such as a vehicle body.

The hybrid vehicle 10 is driven with at least one of the engine 12 and the motor MG as the drive source for travel. In other words, any one of a plurality of travel modes is selectively established in the hybrid vehicle 10; the plurality of travel modes includes (1) engine travel mode that only uses the engine 12 as the drive source for travel, (2) EV travel (motor travel) mode that only uses the motor MG as the drive source for travel, and (3) hybrid travel (EHV travel) mode that uses the engine 12 and the motor MG as the drive sources for travel, for example. In this embodiment, the engine travel mode and the hybrid travel mode correspond to a first travel state where the vehicle travels by using the driving force generated at least by the engine 12 while the clutch K0 is engaged. In this embodiment, the EV travel mode corresponds to a second travel state where the vehicle travels by using the driving force generated by the motor MG while the engine 12 is stopped and the clutch K0 is disengaged.

The engine 12 is an internal combustion engine such as a gasoline engine or a diesel engine of an in-cylinder injection type in which fuel is directly injected in a combustion chamber. An output control device 14 is provided to control drive (output torque) of the engine 12. The output control device 14 includes a throttle actuator that controls opening and closing of an electronic throttle valve, a fuel injection device that controls fuel injection, an ignition device that controls ignition timing, and the like. The output control device 14 executes output control of the engine 12 according to a command supplied from an electronic control unit 50 described below; the output control includes (1) control of opening and closing of the electronic throttle valve by the throttle actuator for throttle control, (2) control of fuel injection by the fuel injection device for fuel injection control, and (3) control of the ignition timing of the ignition device for ignition timing control, for example.

A lock-up clutch LU that directly connects a pump wheel 16p and a turbine wheel 16t so that they can integrally rotate is provided between the pump wheel 16p and the turbine wheel 16t of the torque converter 16. The lock-up clutch LU is controlled such that its engagement state becomes any one of engagement (complete engagement), slip engagement, and disengagement (complete disengagement) according to hydraulic pressure supplied from a hydraulic pressure control circuit 34. A mechanical hydraulic pump 28 is coupled to the pump wheel 16p of the torque converter 16, and hydraulic pressure generated by the hydraulic pump 28 is supplied to the hydraulic pressure control circuit 34 as source pressure along with rotation of the pump wheel 16p.

The transmission 18 is a stepped transmission mechanism that selectively establishes any of a plurality of predetermined gears (gear ratios), for example, and is configured to include a plurality of engagement elements to perform such changes of speed ratios. The transmission 18 includes a plurality of hydraulic frictional engagement devices such as multiple disc clutches and brakes whose engagement is controlled by the hydraulic actuator. In the transmission 18, the plurality of hydraulic frictional engagement devices are selectively engaged or disengaged according to the hydraulic pressure supplied from the hydraulic pressure control circuit 34. Accordingly, any of a plurality (for example, a first gear to a sixth gear) of forward gears (in other words, forward gear positions or forward travel gear positions) or reverse gears (in other words, reverse gear positions or reverse travel gear positions) is selectively established according to a combination of coupling states of the hydraulic frictional engagement devices.

The motor MG includes a rotor 30 and a stator 32. The rotor 30 is rotatably supported around an axis by the transmission case 36. The stator 32 is integrally fixed to the transmission case 36 on an outer peripheral side of the rotor 30. The motor MG is a motor generator that functions as a motor that generates driving force and a generator that generates reaction force. The motor MG is connected to a power storage device 58 such as a battery and a capacitor via an inverter 56. The electronic control unit 50 described below controls the inverter 56, driving current supplied to coils of the motor MG is thereby adjusted, and drive of the motor MG is thereby controlled. In other words, output torque of the motor MG is increased or decreased by control through the inverter 56.

In a power transmission path between the engine 12 and the motor MG, the clutch K0 is provided that controls power transmission in the power transmission path according to an engagement state. In other words, a crankshaft 26 that is an output member of the engine 12 is selectively coupled to the rotor 30 of the motor MG via such a clutch K0. The rotor 30 of the motor MG is coupled to a front cover that is an input member of the torque converter 16. The clutch K0 is, for example, a multiple disc type hydraulic frictional engagement device whose engagement is controlled by the hydraulic actuator. The clutch K0 is controlled such that its engagement state is controlled among engagement (complete engagement), slip engagement, and disengagement (complete disengagement) according to the hydraulic pressure supplied from the hydraulic pressure control circuit 34. That is, a torque capacity of the clutch K0 is controlled according to the hydraulic pressure supplied from the hydraulic pressure control circuit 34. The clutch K0 is engaged, and power transmission is thereby performed (connection is made) in a power transmission path between the crankshaft 26 and the front cover of the torque converter 16. On the other hand, the clutch K0 is disengaged, and power transmission is thereby blocked in the power transmission path between the crankshaft 26 and the front cover of the torque converter 16. The slip engagement of the clutch K0 is made, and power transmission according to the torque capacity (transmission torque) of the clutch K0 is thereby performed in a power transmission path between the crankshaft 26 and the front cover of the torque converter 16.

The hybrid vehicle 10 includes a control system exemplified in FIG. 1. The electronic control unit 50 shown in FIG. 1 is configured to include a microcomputer that includes a CPU, a RAM, a ROM, an input-output interface, and the like. In the electronic control unit 50, the CPU utilizes a temporary storage function of the RAM to perform signal processing according to a program in advance stored in the ROM. Accordingly, the electronic control unit 50 executes various kinds of control such as drive control of the engine 12, drive control of the motor MG, speed change control of the transmission 18, engagement force control of the clutch K0, engagement control of the lock-up clutch LU, and the like. The electronic control unit 50 is separately configured with a plurality of control devices such as for control of the engine 12, control of the motor MG, control of the transmission 18, and control of the clutch K0 according to necessity and may execute each control through communication of information with each other. In this embodiment, the electronic control unit 50 corresponds to the control device of the hybrid vehicle 10.

As shown in FIG. 1, the electronic control unit 50 is supplied with various kinds of input signals detected by each sensor provided in the hybrid vehicle 10. For example, the various kinds of input signals are signals that indicate an accelerator operation amount A_{CC}, a revolution speed N_{E} of the engine 12 (engine revolution speed), a rotational speed N_{T} of the turbine wheel 16t (turbine rotational speed), a rotational speed N_{MG} of the motor MG (motor rotational speed), a temperature T_{MG} of the motor MG, a vehicle speed V, a coolant temperature T_{W} of the engine 12, an intake air amount Q_{A} of the engine 12, power storage amount (remaining capacity, charged amount) SOC of the power storage device 58, and the like. The accelerator operation amount A_{CC} is detected by an accelerator operation amount sensor 62 according to a pedaling effort on an unillustrated accelerator pedal. The engine revolution speed N_{E} is detected by an engine revolution speed sensor 64. The turbine rotational speed N_{T} is detected by a turbine rotational speed sensor 66. The motor rotational speed N_{MG} is detected by a motor rotational speed sensor 68. The temperature T_{MG} is detected by a motor temperature sensor 70. The vehicle speed V is detected by a vehicle speed sensor 72. The coolant temperature T_{W} is detected by a coolant temperature sensor 74. The intake air amount Q_{E} is detected by an intake air amount sensor 76. The power storage amount (remaining capacity, charge amount) SOC is detected by an SOC sensor 78.

The electronic control unit 50 supplies various kinds of output signals to each device provided in the hybrid vehicle 10. For example, the electronic control unit 50 supplies signals such as a signal supplied to the output control device 14 of the engine 12 for drive control of the engine 12, a signal supplied to the inverter 56 for drive control of the motor MG, a signal supplied to a plurality of electromagnetic control valves in the hydraulic pressure control circuit 34 for speed control of the transmission 18, a signal supplied to a linear solenoid valve in the hydraulic pressure control circuit 34 for engagement control of the clutch K0, a signal supplied to the linear solenoid valve in the hydraulic pressure control circuit 34 for engagement control of the lock-up clutch LU, a signal supplied to the linear solenoid valve in the hydraulic pressure control circuit 34 for line pressure control, and the like.

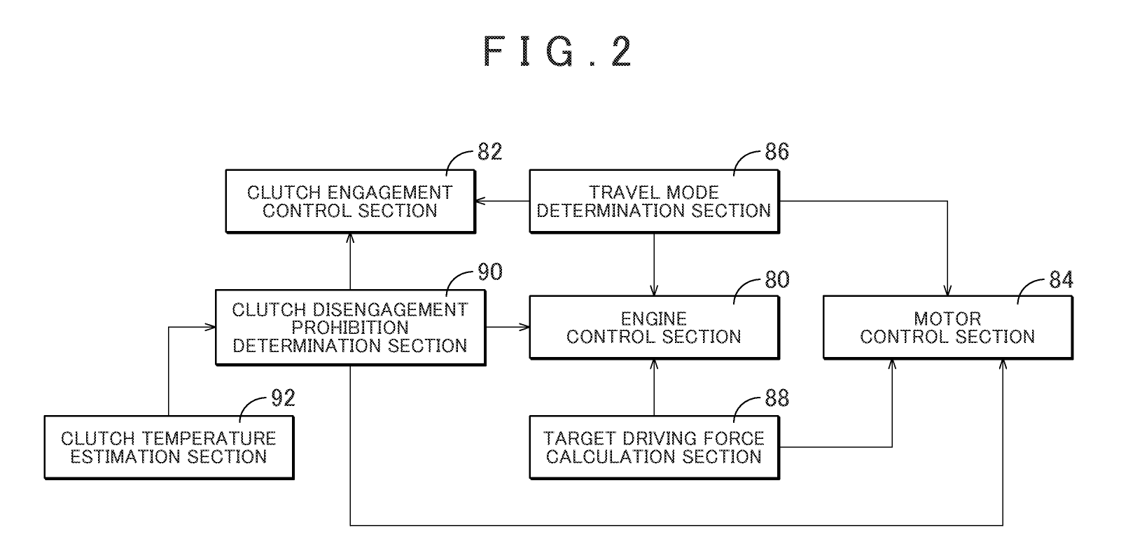

FIG. 2 is a function block diagram that illustrates essential parts of a control function included in the electronic control unit 50. An engine control section 80 shown in FIG. 2 controls the drive (output torque) of the engine 12 via the output control device 14. Specifically, the engine control section 80 controls control made by the output control device 14 of a throttle valve opening θ_{TH} of the electronic throttle valve, a fuel supply amount by the fuel injection device, the ignition timing by the ignition device, and the like and thereby controls the drive of the engine 12 so that engine output required by the engine 12, that is, target engine output can be obtained.

The engine control section 80 drives the engine 12 in the engine travel mode and the hybrid travel (EHV travel) mode. In other words, in switching from the EV travel mode to the engine travel mode or the hybrid travel mode, the engine control section 80 performs engine starting control for starting the engine 12. For example, the engine 12 is started by engaging the clutch K0. In other words, slip engagement or complete engagement of the clutch K0 is made via a clutch engagement control section 82 described below, and the engine 12 is driven to revolve by torque transmitted via the clutch K0. Preferably, in such switching from the disengagement state to the engagement state of the clutch K0, slip engagement of the clutch K0 is retained for at least a prescribed time for reducing a shock. Such revolution drive increases the engine revolution speed N_{E}, and engine ignition and fuel supply are started via the output control device 14, and an operation of the engine 12 is thereby started.

The engine control section 80 stops the engine 12 in the EV travel mode. In other words, in switching from the engine travel mode or the hybrid travel mode to the EV travel mode, the engine control section 80 performs engine stopping control for stopping the engine 12. For example, the clutch K0 is disengaged, and the engine 12 is then stopped. In other words, slip engagement or complete disengagement of the clutch K0 is made via the clutch engagement control section 82 described below, and the engine ignition and the fuel supply are stopped via the output control device 14. Preferably, in such switching from the engagement state to the disengagement state of the clutch K0, the slip engagement of the clutch K0 is retained for at least a prescribed time for reducing a shock.

The clutch engagement control section 82 performs engagement control of the clutch K0 via the linear solenoid valve included in the hydraulic pressure control circuit 34. In other words, a command value to the linear solenoid valve (current supplied to a solenoid) is controlled, and the hydraulic pressure supplied from the linear solenoid valve to the hydraulic actuator included in the clutch K0 is thereby controlled. Such hydraulic pressure control allows control of the engagement state of the clutch K0 among engagement (complete engagement), slip engagement, and disengagement (complete disengagement). The control by the clutch engagement control section 82 allows control of the torque capacity (transmission torque) of the clutch K0 according to the hydraulic pressure supplied from the linear solenoid valve to the clutch K0. That is, the clutch engagement control section 82 is in other words a clutch torque capacity control section that controls the torque capacity of the clutch K0 via the linear solenoid valve included in the hydraulic pressure control circuit 34.

A motor control section 84 controls an actuation of the motor MG via the inverter 56. Specifically, electric energy is supplied from the power storage device 58 to the motor MG via the inverter 56. Accordingly, the motor control section 84 makes control to obtain output required by the motor, that is, a target motor output, control to store electric energy generated by the motor in the power storage device 58 via the inverter 56, and the like.

A travel mode determination section 86 makes a determination on a travel mode established in the hybrid vehicle 10 on the basis of target driving force or the like in the hybrid vehicle 10. For example, a determination is made on which travel mode of the engine travel mode, the EV travel mode, and the hybrid travel (EHV travel) mode is established from a predetermined relationship and on the basis of the vehicle speed V detected by the vehicle speed sensor 72, the accelerator operation amount A_{CC} detected by the accelerator operation amount sensor 62, the power storage amount (remaining capacity, charge amount) SOC of the power storage device 58 detected by the SOC sensor 78, and the like.

In other words, the travel mode determination section 86 makes a determination on switching from the first travel state to the second travel state from the predetermined relationship and on the basis of the vehicle speed V, the accelerator operation amount A_{CC}, the power storage amount SOC, and the like. The first travel mode allows the vehicle to travel by using at least the driving force generated by the engine 12 in the state where the clutch K0 is engaged, that is, the engine travel mode or the hybrid travel mode. The second travel state allows the vehicle to travel by using the driving force generated by the motor MG in the state where the engine 12 is stopped and the clutch K0 is disengaged, that is, the EV travel mode. In a case where the travel mode determination section 86 makes a determination of switching from the first travel state to the second travel state, basically, the clutch engagement control section 82 allows the clutch K0 to make the slip engagement for a prescribed time, the clutch K0 is thereafter completely disengaged, and the engine control section 80 stops the ignition and the fuel supply in the engine 12 via the output control device 14.

A target driving force calculation section 88 calculates a target driving force F_{req} from the predetermined relationship and on the basis of a vehicle state. For example, the target driving force calculation section 88 deduces (calculates) the target driving force F_{req} that is a target value of the driving force to be transmitted to the driving wheels 24 from a map that is in advance set and stored and on the basis of the accelerator operation amount A_{CC} detected by the accelerator operation amount sensor 62, the vehicle speed V detected by the vehicle speed sensor 72, and the like. The target driving force F_{req} may be deduced on the basis of electronic throttle valve opening or the like that corresponds to the accelerator operation amount A_{CC}. The engine control section 80 and the motor control section 84 control the drive of the engine 12 and the action of the motor MG so as to achieve the target driving force F_{req} that is calculated by the target driving force calculation section 88. In the engine travel mode, the engine control section 80 controls the drive of the engine 12 with the target driving force F_{req} calculated by the target driving force calculation section 88 as the target engine output. In the EV travel mode, the motor control section 84 controls the drive of the motor MG with the target driving force F_{req} calculated by the target driving force calculation section 88 as the target motor output. Here, in a case where a brake is depressed during an accelerator off state or the like, the target driving force F_{req} calculated by the target driving force calculation section 88 may become a negative value. In such a case, the engine control section 80 and the motor control section 84 preferably control the drive of the engine 12 and the actuation of the motor MG so as to achieve the negative target driving force F_{req} by engine brake torque of the engine 12, regenerative torque of the motor MG, and the like.

A clutch disengagement prohibition determination section 90 makes a determination whether or not disengagement of the clutch K0 is prohibited. In other words, a determination is made whether or not execution of disengagement control (including temporary slip engagement control) of the clutch K0 from a state where the clutch K0 is engaged is prohibited. Such a determination is preferably made on the basis of estimation results of a clutch temperature estimation section 92 that will be described in detail below. The clutch temperature estimation section 92 estimates the temperature of the clutch K0. The temperature of the clutch K0 is preferably estimated on the basis of input-output rotational speed difference ΔN of the clutch K0, that is, a rotational speed difference between the engine revolution speed N_{E} and the motor rotational speed N_{MG}. For example, an estimated temperature T_{C} of the clutch K0 at next engagement is repeatedly calculated in a prescribed calculation cycle such as several hundred milliseconds to several thousand milliseconds by the following equations (1) to (3) in advance stored in a form of a functional equation or a map and on the basis of the actual rotational speed N_{MG} (rpm) of the motor MG detected by the motor rotational speed sensor 68, the actual revolution speed N_{E} (rpm) of the engine 12 detected by the engine revolution speed sensor 64, transmission torque TR (Nm) of the clutch K0, and an actual hydraulic oil temperature Tₒᵢₗ (° C.) detected by an unillustrated oil temperature sensor or the like.

Tc=Tc⁻¹+ΔTu−ΔTd (1)

### Here,

ΔTu=f((N_{MG}−N_{E}), TQ)/Cc (2)

ΔTd=λ×S×(Tc⁻¹−Tₒᵢₗ) (3)

In the equation (1), a term Tc⁻¹ is an estimated temperature (an initial value is the atmospheric temperature) of the clutch K0 that is calculated in a previous calculation cycle. A term ΔTu is an estimated temperature increase of the clutch K0 from the previous calculation cycle. A term ΔTd is an estimated temperature decrease of the clutch K0 from the previous calculation cycle. In the equation (2), a term TQ is a transmission torque of the clutch K0 (for example, cranking torque at a time when the engine 12 is started). A term Cc is a heat capacity (cal/° C.) of the clutch K0. In the equation (3), a term 2 is thermal conductivity of the clutch K0. A term S is a surface area of the clutch K0. In the equation (2), although the transmission torque TQ of the clutch K0 may be the torque at the time when the engine is started and a constant value, the transmission torque can be calculated from an empirical formula that is obtained in advance and on the basis of a hydraulic pressure command value of the clutch K0. In the equation (2), f((N_{MG}−N_{E}), TQ) is an empirical formula that is obtained in advance to calculate heat generation (cal) of the clutch K0 as a function of differential rotation (N_{MG}−N_{E}) of the clutch K0 and the transmission torque TQ of the clutch K0 that corresponds to pressing force at that time. When the engine 12 is started, the revolution speed N_{E} is zero to approximately several hundreds (rpm). In the equations (2) and (3), terms Cc, α, and S are constant values, and terms N_{MG}, N_{E}, TQ, and Tₒᵢₗ are variables.

The estimated temperature Tc of the clutch K0 is stored as a functional equation or a data map as a function F expressed by the equation (1) to an equation (4) shown below. The variables N_{MG}, N_{E}, TQ, Tₒᵢₗ are actual status parameters that influence the temperature Tc of the clutch K0 and repeatedly obtained every calculation cycle as an average value from the previous calculation cycle.

Tc=F(N_{MG}, N_{E}, TQ, Tₒᵢₗ) (4)

The clutch temperature estimation section 92 may estimate the temperature Tc of the clutch K0 on the basis of another relationship than the equations (1) to (4). For example, an integrated value of the differential rotation ΔN (=N_{MG}−N_{E}) of the clutch K0 within a specified time is calculated, and the estimated temperature Tc of the clutch K0 may thereby be calculated from a predetermined relationship and on the basis of the integrated value. In such a mode, the estimated temperature Tc of the clutch K0 preferably becomes higher as the integrated value of the differential rotation ΔN of the clutch K0 is larger. Alternatively, the clutch K0 may include a temperature sensor, and an actual temperature detected by the temperature sensor may serve as the estimated temperature Tc of the clutch K0.

The clutch disengagement prohibition determination section 90 preferably makes a determination of prohibiting disengagement of the clutch K0 in a case where the temperature Tc of the clutch K0 estimated by the clutch temperature estimation section 92 is a specified threshold that is set in advance or larger. In the case where the clutch disengagement prohibition determination section 90 makes the determination of prohibiting disengagement of the clutch K0, the disengagement control (including the temporary slip engagement control) of the clutch K0 is not executed even if the travel mode determination section 86 makes the determination of switching from the first travel state to the second travel state. In such a mode, after the temperature Tc of the clutch K0 estimated by the clutch temperature estimation section 92 becomes less than the threshold and the clutch disengagement prohibition determination section 90 does not retain the determination of prohibiting disengagement of the clutch K0 (after disengagement of the clutch K0 is permitted), the disengagement control of the clutch K0 is executed, and the switching from the engine travel mode or the hybrid travel mode to the EV travel mode is performed.

In this embodiment, in switching from the first travel state (the engine travel mode or the hybrid travel mode) to the second travel state (the EV travel mode), in the case where the clutch disengagement prohibition determination section 90 makes the determination of prohibiting disengagement of the clutch K0, an operation of the engine 12 is maintained after the target driving force of the engine 12 changes to a negative value. In other words, an idling operation of the engine 12 is performed until disengagement of the clutch K0 is permitted. That is, the engine control section 80 performs idling control of the engine 12 via the output control device 14 or the like. In other words, control is performed in which the engine 12 is driven at an idling revolution speed N_{EIDL}.

In this embodiment, in switching from the first travel state to the second travel state, in the case where the clutch disengagement prohibition determination section 90 makes the determination of prohibiting disengagement of the clutch K0, control is preferably made such that the output torque (absolute value) of the engine 12 becomes as small as possible until disengagement of the clutch K0 is permitted. In other words, control is made such that a target value of the output torque of the engine 12, that is, the target engine output becomes approximately zero. For example, the engine control section 80 performs the idling operation of the engine 12 via the output control device 14 or the like, and the motor control section 84 controls the actuation of the motor MG so that the engine brake torque of the engine 12 is cancelled by the output torque of the motor MG. In other words, while the engine 12 performs the idling operation, the motor MG generates motor torque that covers the torque of the engine brake so that friction torque of the crankshaft 26 that is an output shaft of the engine 12 becomes approximately zero.

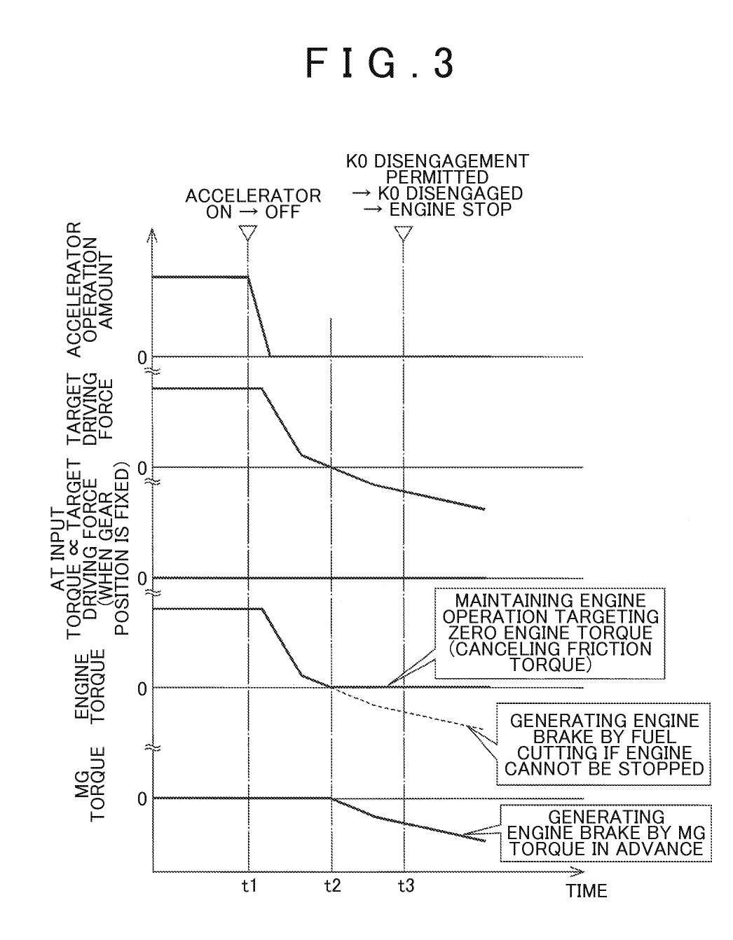

FIG. 3 is a time chart that illustrates an example of control in this embodiment in the case where the clutch disengagement prohibition determination section 90 makes the determination of prohibiting disengagement of the clutch K0 in switching from the first travel state to the second travel state. In the time chart, relation values in a case where the control of this embodiment is applied are shown by solid lines, and relation values in accordance with control in a case where this embodiment is not applied are shown by a broken line. In the control shown in FIG. 3, switching is made from an accelerator on state to the accelerator off state at a point t1. In other words, because of release of an accelerator pedal from a pedaling operation or the like, the accelerator operation amount A_{CC} detected by the accelerator operation amount sensor 62 decreases and further becomes zero. The target driving force F_{req} gradually decreases along with the decrease of the accelerator operation amount A_{CC}. In the control shown in FIG. 3, the target driving force F_{req} becomes zero at a point t2 and thereafter becomes a negative value. Here, as shown by the broken line in FIG. 3, in the control in the case where this embodiment is not applied, in a case where the drive of the engine 12 cannot be stopped because disengagement of the clutch K0 is prohibited at the point t2, engine brake is caused by fuel cutting or the like in the engine 12, for example. In other words, the negative target driving force F_{req} is achieved by such an engine brake. However, in case the control in which this embodiment is not applied, when disengagement of the clutch K0 is permitted at a point t3, for example, and control to actually disengage (preferably disengagement after the temporary slip engagement control) the clutch K0 is performed, the engine braking effect may be temporary reduced because the friction torque is reduced, and a driver may experience awkwardness. That is, even when the clutch K0 is sufficiently cooled and its disengagement is permitted, once the target driving force F_{req} enters a range where deceleration force that corresponds to the engine brake is secured, it becomes difficult to disengage the clutch K0 in consideration of a shock and the inactivation of the engine brake (that is, in consideration of drivability). In particular, in a case where a second clutch that blocks a power transmission path is not provided in the power transmission path from an input shaft to an output shaft of the transmission 18 or a case where slip engagement of the second clutch cannot be performed, it is difficult to disengage the clutch K0 in consideration of drivability. It should be noted that the second clutch is one that is provided in the power transmission path between the motor MG and the driving wheels 24 and can change the torque capacity.

On the other hand, in the control of this embodiment that is shown in FIG. 3, in the case where the drive of the engine 12 cannot be stopped because disengagement of the clutch K0 is prohibited at the point t2, the idling operation of the engine 12 is performed until disengagement of the clutch K0 is permitted. In other words, the output control device 14 maintains the operation of the engine 12 after the target driving force of the engine 12 changes to a negative value at the point t2. As shown in FIG. 3, while the engine 12 performs the idling operation, the motor MG preferably generates negative torque such that the friction torque of the crankshaft 26 that is the output shaft of the engine 12 becomes approximately zero. That is, the engine brake is generated (covered) in advance by the torque of the motor MG. In such control, in the case where the disengagement of the clutch K0 is permitted at the point t3 shown in FIG. 3, the temporary reduction of the engine braking effect does not occur even if the control to actually disengage the clutch K0 is performed. As described above, in the control of this embodiment, coverage of the torque for the engine brake by the engine torque and MG torque is changed in advance, a shock due to stop of the engine 12 can be reduced. In other words, both of an improvement in fuel efficiency and drivability can be achieved.

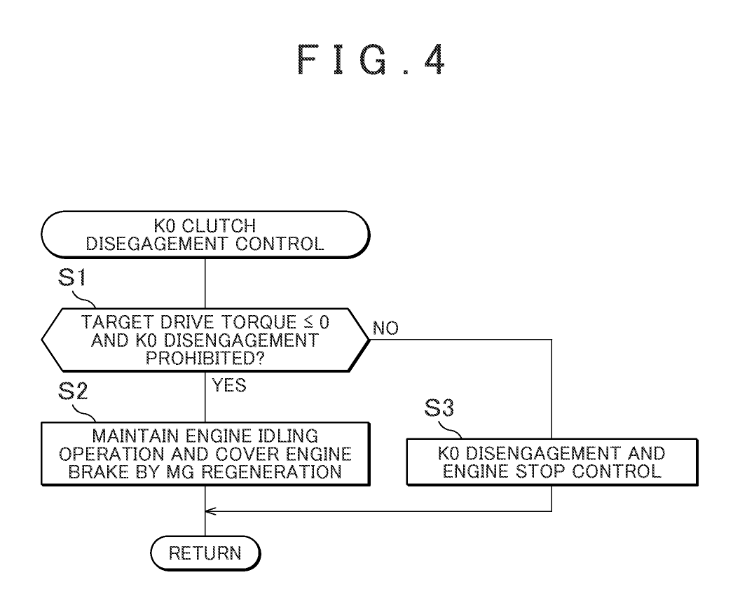

FIG. 4 is a flowchart that illustrates essential parts of an example of clutch disengagement control by the electronic control unit 50 in a case where the determination of switching from the engine travel mode or the hybrid travel mode to the EV travel mode is made. The flowchart of FIG. 4 is repeatedly executed by the electronic control unit 50 in a prescribed period.

First, in step (hereinafter “step” will be omitted) S1, a determination is made whether or not the target driving force F_{req} is zero or less and disengagement of the clutch K0 is prohibited. If the determination in S1 is YES, in S2, control is made such that the idling operation of the engine 12 is performed until disengagement of the clutch K0 is permitted and the output torque (absolute value) of the engine 12 becomes as small as possible. For example, after the engine brake torque is covered by the regenerative torque of the motor MG, this routine is finished. If the determination in S1 is NO, in S3, the clutch K0 is disengaged, control to stop the drive of the engine 12 is executed, and this routine is thereafter finished. In the above control, S1 corresponds to an operation of the clutch disengagement prohibition determination section 90, and S2 and S3 correspond to operations of the engine control section 80, the clutch engagement control section 82, and the motor control section 84.

As described above, according to this embodiment, in switching from the first travel state (the engine travel mode or the hybrid travel mode) to the second travel state (the EV travel mode), in the case where disengagement of the clutch K0 is prohibited, the operation of the engine 12 is maintained after the target driving force of the engine 12 changes to a negative value. Accordingly, occurrence of the temporary reduction of the engine braking the effect caused by reduction of the friction torque in disengagement of the clutch K0 can properly be hindered.

In the above embodiment, in switching from the first travel state to the second travel state, in the case where disengagement of the clutch K0 is prohibited, the control is made such that the output torque of the engine 12 becomes as small as possible until disengagement of the clutch K0 is permitted. Accordingly, for example, the engine brake is in advance covered by the torque of the motor MG, and the occurrence of the temporary reduction of the engine braking effect can further properly be hindered.

The above embodiment is preferably applied to a hybrid vehicle in which the crankshaft of the engine is connected to the rotor of the motor via the clutch and which includes the torque converter and the automatic transmission in the power transmission path between the rotor and the drive wheels. The present invention is not limited thereto but may be applied to a hybrid vehicle that includes the automatic transmission without having the torque converter in the power transmission path between the motor and the drive wheels as another embodiment of the present invention.

A preferable embodiment of the present invention has been described in detail so far with the drawings. However, the present invention is not limited thereto but can be applied with various modifications without departing the gist thereof.

What is claimed is:

1. A control device for a vehicle that includes an engine, a motor, and a clutch provided in a power transmission path between the engine and the motor, the control device comprising
an electronic control unit configured to switch travel states between a first travel state and a second travel state, wherein the vehicle travels by using driving force generated by at least the engine while the clutch is engaged in the first travel state and the vehicle travels by using driving force generated by the motor while the engine is stopped and the clutch is disengaged in the second travel state,
the electronic control unit being configured to maintain an operation of the engine and keep the clutch engaged after target driving force of the engine changes to a negative value in a case where disengagement of the clutch is prohibited in switching from the first travel state to the second travel state.

2. The control device according to claim 1, wherein
the electronic control unit is configured to make output torque of the engine small until disengagement of the clutch is permitted in a case where disengagement of the clutch is prohibited in switching from the first travel state to the second travel state.

3. The control device according to claim 1, wherein
the electronic control unit is configured to make output torque of the engine approximately zero and keep the clutch engaged until disengagement of the clutch is permitted in a case where disengagement of the clutch is prohibited in switching from the first travel state to the second travel state.

4. The control device according to claim 3, wherein
the electronic control unit is configured to cause the motor to generate torque that cancels engine brake torque of the engine until disengagement of the clutch is permitted in a case where disengagement of the clutch is prohibited in switching from the first travel state to the second travel state.

5. The control device according to claim 3, wherein
the electronic control unit is configured to cause the motor to generate torque that makes friction torque of an output shaft of the engine approximately zero until disengagement of the clutch is permitted in a case where disengagement of the clutch is prohibited in switching from the first travel state to the second travel state.

6. The control device according to claim 3, wherein
the electronic control unit is configured to cause the motor to generate negative torque that cancels friction torque of an output shaft of the engine until disengagement of the clutch is permitted in a case where disengagement of the clutch is prohibited in switching from the first travel state to the second travel state.

7. A control method for a vehicle which includes an engine, a motor, and a clutch provided in a power transmission path between the engine and the motor, the control method comprising
maintaining an operation of the engine and keeping the clutch engaged with an electronic control unit, after target driving force of the engine changes to a negative value in a case where disengagement of the clutch is prohibited when travel states of the vehicle switch from a first travel state to a second travel state, wherein the vehicle travels by using driving force generated by at least the engine while the clutch is engaged in the first travel state and the vehicle travels by using driving force generated by the motor while the engine is stopped and the clutch is disengaged in the second travel state.

8. The control device according to claim 7, further comprising:
making output torque of the engine small with the electronic control unit, until disengagement of the clutch is permitted in a case where disengagement of the clutch is prohibited in switching from the first travel state to the second travel state.

9. The control method according to claim 7, further comprising:
making output torque of the engine approximately zero and keeping the clutch engaged with the electronic control unit, until disengagement of the clutch is permitted in a case where disengagement of the clutch is prohibited when the travel states switch from the first travel state to the second travel state.

10. The control method according to claim 9, further comprising:
generating torque that cancels engine brake torque of the engine until disengagement of the clutch is permitted in a case where disengagement of the clutch is prohibited in switching from the first travel state to the second travel state.

11. The control method according to claim 9, further comprising:
generating torque that makes friction torque of an output shaft of the engine approximately zero until disengagement of the clutch is permitted in a case where disengagement of the clutch is prohibited in switching from the first travel state to the second travel state.

12. The control device according to claim 9, wherein
generating negative torque that cancels friction torque of an output shaft of the engine with the motor, until disengagement of the clutch is permitted in a case where disengagement of the clutch is prohibited in switching from the first travel state to the second travel state.
